(19) United States
(12) Patent Application Publication
(10) Pub. No.: US 2009/0150785 A1
(43) Pub. Date: Jun. 11, 2009

(54) Input device for inputting voice information including voice recognizer

(75) Inventors: Katsushi Asami, Nukata-gun (JP); Ichiro Akahori, Anjo-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/292,710

(22) Filed: Nov. 25, 2008

(30) Foreign Application Priority Data
Dec. 5, 2007 (JP) 2007314601

(51) Int. Cl. G06F 3/16; G10L 15/26

(52) U.S. Cl. 715/727; 704/235; 704/E15.001

(57) ABSTRACT

An input device for inputting a command to an electronic system such as an on-board navigation system includes a microphone for inputting voice, a voice recognizer for analyzing the inputted voice and comparing it with data stored in a voice recognition dictionary, a touch panel displaying keys corresponding to the inputted voice and a controller for controlling operation of the input device. User's voice inputted from the microphone is fed into the voice recognizer to calculate a degree of coincidence with the data in the voice recognition dictionary. The keys corresponding to the inputted voice having a high degree of coincidence are displayed on the touch panel in an enlarged size. The enlarging rates may be determined according to the degree of coincidence. The user is able to finalize, easily and quickly, the keys constituting a command by touching the panel because candidate keys are enlarged.

### CROSS-REFERENCE TO RELATED APPLICATION

This application is based upon and claims benefit of priority of Japanese Patent Application No. 2007-314601 filed on Dec. 5, 2007, the content of which is incorporated herein by reference.

### BACKGROUND OF THE INVENTION

1. Field of the Invention

The present invention relates to a device for inputting commands to an electronic system such as a navigation system.

2. Description of Related Art

An input device for inputting characters intended by a user is known hitherto. In this device, user's voice is recognized by a voice recognizer to specify characters intended by the user, and the recognized characters are inputted as a command to an electronic system such as a navigation system. However, there is a problem that the characters that are not correctly recognized by the voice recognizer are inputted as a command to the system. To avoid this problem, JP-A-2007-212658 proposes to display characters recognized by the voice recognizer in a highlighted manner and let a user to finalize the intended characters by touching the displayed characters.

The input device proposed by JP-A-2007-212658 is used in a car navigation system which has a display panel having a limited display area. The characters shown in the display panel having a limited area are not easy to quickly specify and to touch them correctly even if the characters are shown in a highlighted manner.

### SUMMARY OF THE INVENTION

The present invention has been made in view of the above-mentioned problem, and an object of the present invention is to provide an improved input device for inputting a command to a system quickly and correctly.

The input device of the present invention is used for inputting commands to an electronic system such as a navigation system mounted on an automotive vehicle. The input device includes a microphone for inputting voice information such as a syllable or a word, a voice recognizer including a voice recognition dictionary, a display panel such as a liquid crystal display panel displaying a touch panel thereon, and a controller for controlling operation of the display panel and other components. The touch panel displays keys such as keys corresponding to 50 Japanese characters and other associated marks.

Upon inputting voice information such as a syllable or a word from the microphone, the voice recognizer analyzes the inputted voice and compares it with data stored in the voice recognition dictionary. The controller calculates a degree of coincidence between the inputted voice and the dictionary data. The degree of coincidence represents likelihood of voice recognition. Keys displayed on the touch panel corresponding to the inputted voice having likelihood higher than a predetermined level are enlarged. The enlarging rates are determined according to the degree of coincidence. The user of the input device touches one or more keys displayed on the touch panel in an enlarged size, thereby to finalize the keys to be inputted as a command.

Preferably, the enlarged keys are displayed not to overlap the other keys that are not enlarged. In the enlarging process, the keys may be gradually enlarged so that the user is able to more easily recognize the enlarged keys. The enlarged keys may be returned to an original size after a predetermined period has lapsed. In reducing the size of the keys, it may be gradually reduced. Alternatively, the keys having a lower degree of coincidence may be eliminated from the display so that the keys having a higher degree of coincidence are more clearly shown to the user. The voice recognizer may be put into operation upon initiation of inputting the voice information.

According to the present invention, the user can easily and quickly finalize the correct keys for inputting a command by touching the touch panel since the candidate keys are enlarged. Other objects and features of the present invention will become more readily apparent from a better understanding of the preferred embodiment described below with reference to the following drawings.

### BRIEF DESCRIPTION OF THE DRAWINGS

FIG. 1 is a block diagram showing a navigation system mounted on an automotive vehicle;

FIG. 2 is a flowchart showing a process of inputting a syllable or a word to an input device;

FIG. 3A is a plan view showing a keyboard displayed on a display panel;

FIG. 3B is a plan view showing the same keyboard shown in FIG. 3A, with certain characters shown in an enlarged size;

FIG. 3C is a plan view showing the same keyboard shown in FIG. 3A, with a function key “History” shown in an enlarged size; and

FIGS. 4A-4C are drawings corresponding to FIGS. 3A-3C, in which a keyboard showing a Japanese syllabary is replaced with a keyboard showing an alphabet.

### DETAILED DESCRIPTION OF THE PREFERRED EMBODIMENT

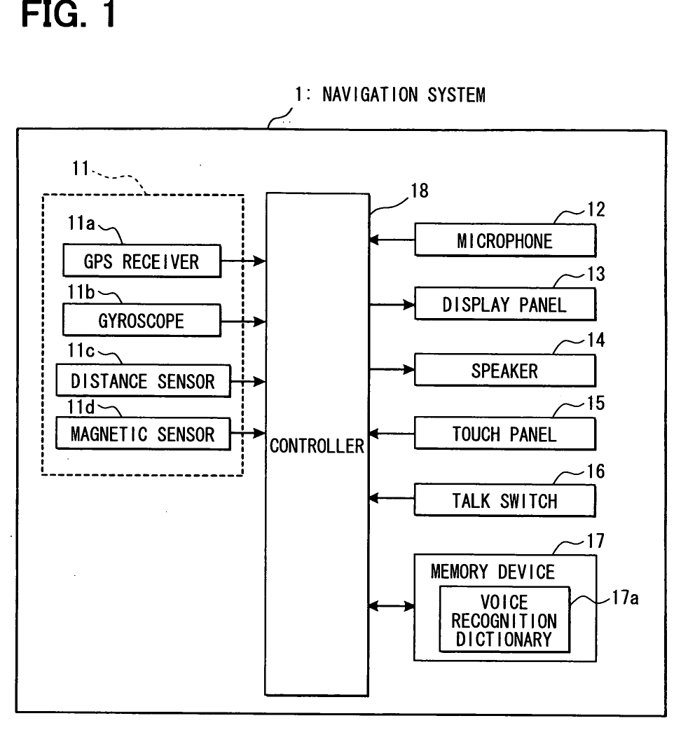

A first embodiment of the present invention will be described with reference to accompanying drawings. First, an entire structure of a navigation system 1 mounted on an automotive vehicle will be briefly described with reference to FIG. 1.

The navigation system 1 includes: a position detector 11 that detects a present position of a vehicle; a microphone 12 that outputs electric signal based on voices inputted by a user; a display panel 13 for displaying various information including maps; a speaker 14 for outputting sound information to the user; a touch panel 15 (including mechanical switches disposed around the panel) for inputting commands from the user; a talk switch 16 that is operated when the user inputs his/her voices to the speaker; a memory device 17 for storing map data and other information therein; and a controller 18. The memory device 17 also stores a voice recognition dictionary 17a. The controller 18 that performs various processes according to signals from the position detector 11, the microphone 12, the touch panel 15, the talk switch 16 and the memory device 17, and controls the display panel 13, the speaker 14 and memory device 17.

The position detector 11 includes: a GPS (Global Positioning System) receiver 11a that receives electromagnetic waves transmitted from GPS satellites through a GPS antenna and detects positions and directions of the vehicle; a gyroscope 11b for detecting an amount of rotation given to the vehicle; a distance sensor 11c for detecting a distance from an acceleration in a front to rear direction of the vehicle; and a magnetic sensor 11d for detecting a driving direction from a terrestrial magnetic field. Since these sensors 11a-11d include specific errors, these sensors are used while compensating respective errors one another. It is possible to eliminate some sensors, or to use a steering sensor or a wheel speed sensor in addition to or in place of some of the sensors.

The navigation system 1 is operated according to commands inputted by a user through the microphone 12. The display panel 13 is a color display panel, and it can be constituted by a liquid crystal display panel, a plasma display panel, a cathode ray tube or an organic electroluminescent panel. A present position of the vehicle detected by the position detector 11, a map data fed from the memory device 17, a calculated route to a destination, names of facilities, etc. are displayed on the display panel 13 in an overlapped manner.

The touch panel 15 is integrally formed with the display panel 13 by laminating on each other. The touch panel 15 may be constituted by a pressure-sensitive panel, an electromagnetic induction panel, an electrostatic capacitance panel or a combination of these panels. The touch panel 15 may be formed also by devices other than those listed above. The talk switch 16 is disposed on a steering wheel of the vehicle so that a driver can easily operate it. The memory device 17 stores therein various data such as map data, so-called map-matching data for improving accuracy in determining a position of the vehicle, a navigation program to be performed by the controller 18, and voice recognition dictionary 17a. The memory device 17 is composed of a magnetic memory such as a hard disc or the like, considering a large amount of data to be stored.

The controller 18 is a known microcomputer including CPU, ROM, RAM, I/O, bus lines and other components. The controller 18 calculates a present position of the vehicle (a pair of a coordinate and a driving direction) based on the signals fed from the position detector 11 and the map data fed from the memory device 17 according to a program stored in the memory device 17. The controller 18 displays a map around the present position on the display panel 13 together with a driving route to a destination. The destination is inputted by a driver's voice through the microphone 12, and an optimum route to the destination is calculated in the controller 18. The driver is guided to the destination by voice instructions through the speaker 14.

The controller 18 also includes a function to make a conversation with the driver and to receive driver's commands by voice. The controller 18 performs a process for inputting the user's commands by characters through the touch panel 15 and by voice through the microphone 12.

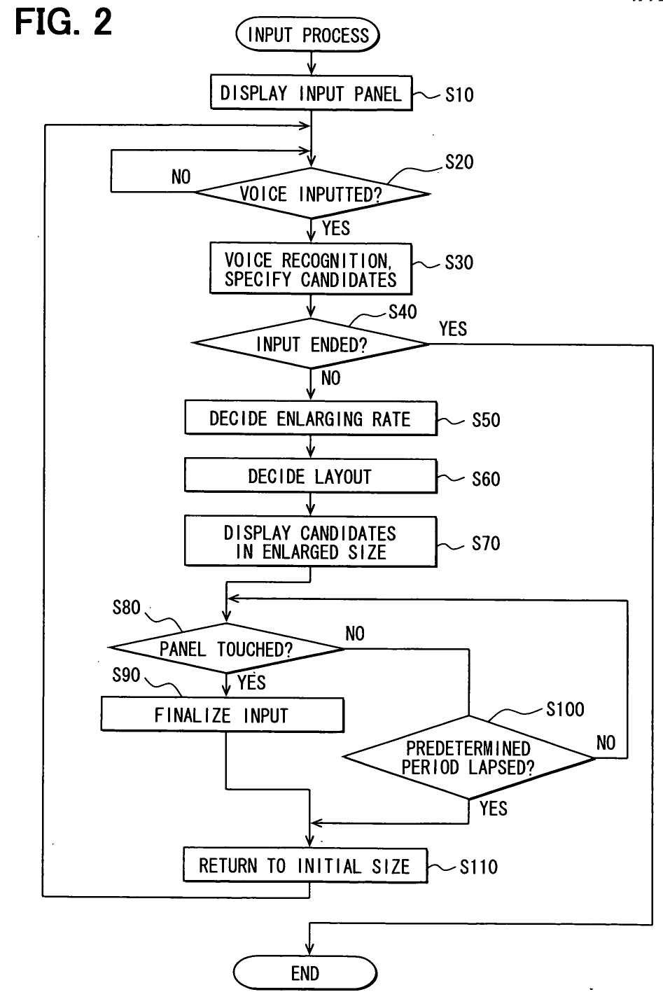

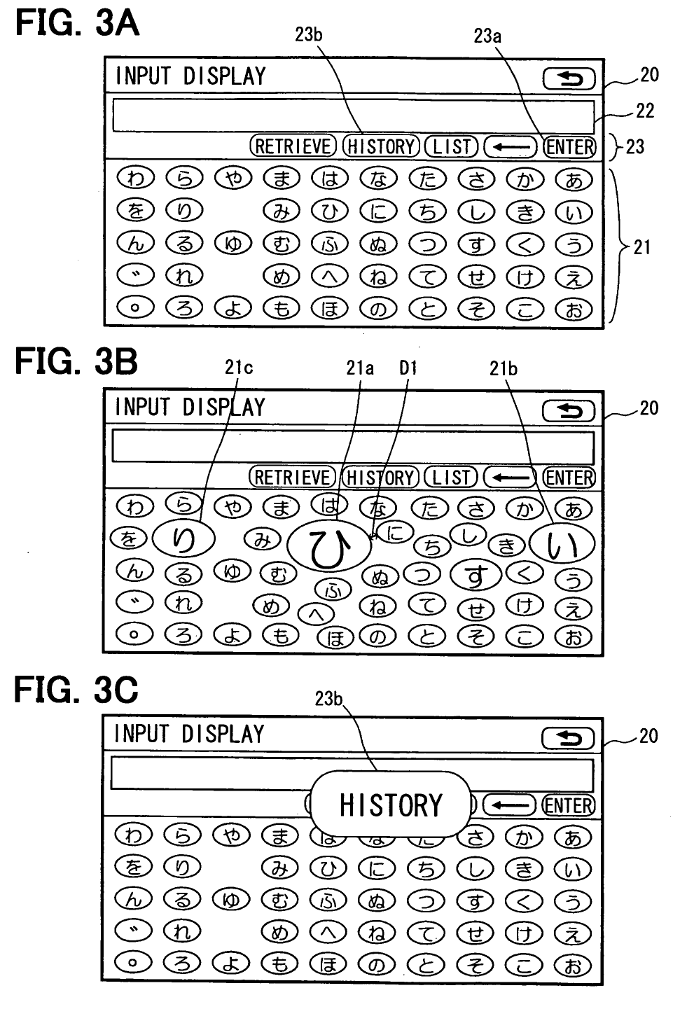

With reference to FIG. 2, a process of inputting a syllable or a word by voice will be described. The inputting process is started every time when the talk switch 16 is operated. Upon starting the process, an input display 20 shown in FIG. 3A is displayed on the display panel 13 at step S10. The input display 20 includes syllabary keys 21 having 50 Japanese characters and other marks, a portion 22 for displaying characters inputted and function keys 23. Each one of the Japanese characters corresponds to a syllable, and a Japanese word is composed of one or plural syllables. The function keys 23 include an Enter key 23a for finalizing a character or a word to be inputted, a History key 23b for displaying again characters previously displayed. The syllabary keys 21 and the function keys 23 are collectively referred to as input keys.

Then, at step S20, whether voice is inputted to the microphone 12 or not is determined. If not, the process awaits a voice input. If the voice is inputted, the process proceeds to step S30 to perform voice recognition. In the voice recognition step, the voice inputted from the microphone 12 is analyzed and compared with data stored in the voice recognition dictionary 17a. A degree of coincidence between the inputted voice and the dictionary data is calculated. One or more candidates having the degree of coincidence higher than a predetermined level are selected from among the 50 characters. For example, characters having the degree of coincidence higher than 50% are selected as candidates. These candidates are considered to have a certain level of likelihood. In other words, the degree of coincidence corresponds to the likelihood in voice recognition.

At step S40, whether the input is terminated or not is determined. This determination is done when a command word “end” is inputted and the word is recognized as the one having the highest degree of coincidence. If it is determined that the input is terminated, the process proceeds to the end. If not, the process proceeds to step S50, where enlarging rates of the input keys (the syllabary keys 21 or the function keys 23) corresponding to the candidates are calculated. For example, the enlarging rate of an input key corresponding to a candidate having the highest degree of coincidence is set to 300%. The enlarging rate of the second one is set to 200% and that of the third one is set to 150%. The enlarging rates are set according to the degree of coincidence.

At step S60, a layout of the input keys is determined. More particularly, if three syllabary keys 21 (21a, 21b and 21c) are to be enlarged as shown in FIG. 3B, the layout is arranged so that all the keys do not overlap on one another. In other words, a distance D1 shown in FIG. 3B is made larger than predetermined distance. In the example shown in FIG. 3B, the enlarging rate of key 21a is the highest, key 21b is the second, and key 21c is the third. If one of the function keys “History” is to be enlarged as shown in FIG. 3C, the “History” key 23b is shown over other functions keys that are not enlarged. When the input keys are enlarged, they are displayed in a gradually enraging manner (animated manner).

At step S80, whether input keys displayed on the touch panel 15 are touched or not is determined. If the input keys are touched, the touched input keys (syllabary keys 21 or function keys 23) are determined as the final input keys at step S90. Then, the process proceeds to step S110, where the input display 20 returns to an initial state. If the input keys are not touched at step S80, the process proceeds to step S100, where it is determined that a predetermined period has lapsed after the keys are enlarged. The process returns to step S80 to await the lapse of the predetermined period. If it is determined that the predetermined period has lapsed at step S100, the process proceeds to step S110, where the input display 20 returns to the initial state. When the enlarged input keys are reduced to the initial size, the size is gradually reduced (animated). The process returns to step S20 after the input display 20 is returned to the initial state to repeat the same process described above.

As explained above, the voice inputted from the microphone 12 is subjected to the voice recognition, and the input keys corresponding to the voice recognized with high likelihood are enlarged on the touch panel 15. The input keys are finalized by touching the enlarged keys on the touch panel 15.

The following advantages are attained in the embodiment described above. Since the keys having high likelihood are enlarged on the touch panel 15, the user can easily and quickly touch desired input keys. The characters on the input keys are easily seen by the user by enlarging the input keys even if the characters are small in size in the initial state. Since the input keys are enlarged according to the degree of coincidence, the character having the highest likelihood is displayed with the largest size, and therefore the user can easily select the most desired character even when there are plural candidates.

The input keys are finally confirmed by the user by touching the keys enlarged on the touch panel 15. Since the keys are gradually enlarged, the user can further easily find the desired keys on the touch panel 15. Since the size of the enlarged keys is reduced to the normal size after a predetermined period has lapsed, it is not required for the user to do some actions for returning the keys to the initial size. Since the size of the enlarged key is gradually reduced to the normal size, the user can easily recognize the key that is reduced to the normal size.

Since the syllabary keys are displayed on the display panel 13 not to overlap one another when they are enlarged, other keys not enlarged are also visible so that the user can select desired keys from the other keys if the desired keys are not found among the enlarged keys. Since the enlarged function keys 23 are displayed in an overlapped manner on other function keys not enlarged, a process for avoiding the overlapping can be eliminated. Since the inputting process is started every time when the talk switch 16 is operated, commands can be inputted to the device such as a navigation system whenever such is desired by the user.

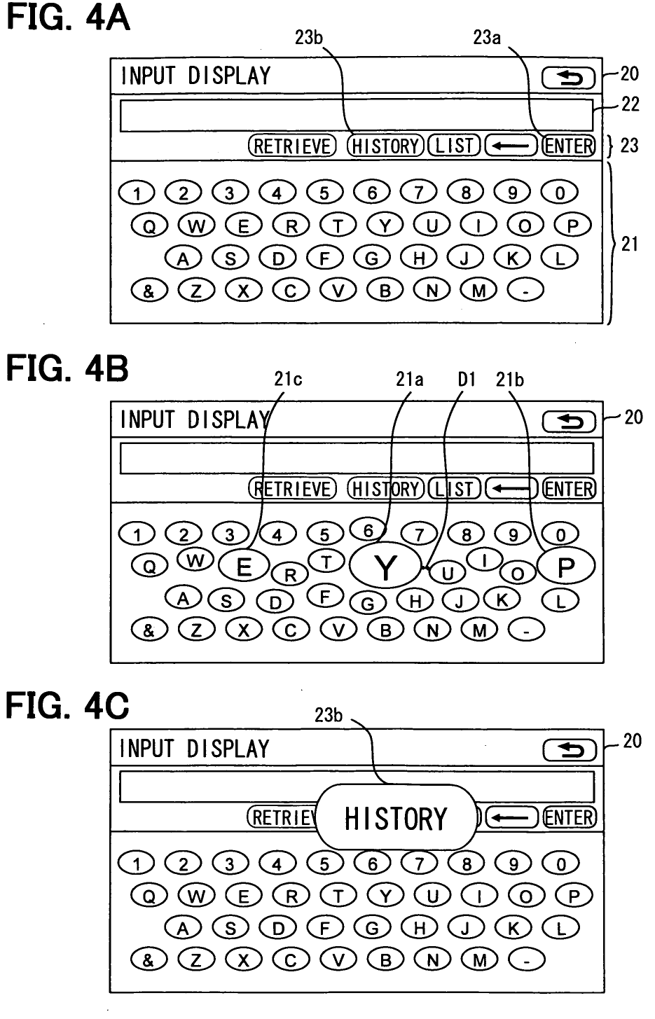

The present invention is not limited to the embodiment described above, but it may be variously modified. For example, the input display 20 is not limited to the one having Japanese syllabary keys (shown in FIGS. 3A, 3B and 3C). It may be replaced with the input display having English alphabet keys (shown in FIGS. 4A, 4B and 4C). The inputting process can be similarly performed in this case, too.

The input keys displayed on the display panel 13 may be selected not only by touching with a finger but also by a pointer. The shape of the enlarged input keys is not changed in the foregoing embodiment. It is possible to change their shape when enlarged. The enlarging rates are not limited to the example shown above. The enlarging rates can be arbitrarily selected as long as the candidate keys are distinguished from other keys. Further, the enlarging rates may be continuously changed according to the degree of coincidence.

The minimum distance D1 (FIG. 3B) is secured between an enlarged key and a non-enlarged key in the foregoing embodiment. It is also possible to arrange a flexible layout of the input keys to provide a minimum distance between neighboring keys by setting hypothetical springs among keys and end margins of the display panel under a simulation of dynamical mechanics.

Though the syllabary keys 21 are enlarged not to overlap one another in the foregoing embodiment, it is also possible to display the enlarged keys to partially overlap with other keys, avoiding completely hiding other keys behind the enlarged keys. Only the candidate syllabary keys 21 may be displayed while erasing all of the other keys. In this case, the candidate keys may be either enlarged or not enlarged. The user can easily select desired keys from the candidate keys.

Though the candidate keys having a higher degree of coincidence are enlarged in the foregoing embodiment, it is possible to reduce the size of non-candidate keys, instead. In this case, the size of the non-candidate keys may be gradually reduced in an animation-like manner. The reduced keys may be returned to the original size after a predetermined period (e.g., 5 seconds) has lapsed to eliminate any user's action for returning to the original size. Further, the reduced keys may be gradually returned to the original size in an animation-like manner. The rates of reducing the size of the keys 21 may be arbitrary set as long as the reduced keys are easily distinguished from other keys by the user.

A combination of keys 21 which has a low possibility to be a candidate may be determined based on preliminary data or the degree of coincidence calculated at step S30. Though the inputting process is started by operating the talk switch 16 in the foregoing embodiment, it is possible to keep the inputting process active all the time during which power is supplied to the navigation system. In this manner, murmuring or conversation with another person can be inputted to the microphone 12 to select a candidate word from the murmuring or the conversation to display it in an enlarged manner on the display panel 13. For example, a word “History” may be selected from an utterance “it could be found in History.” If the “History” is picked up, the function key 23b “History” is displayed in an enlarged manner.

Though the input process is terminated when the word “end” is recognized at step S40, it is possible to terminate the inputting process when a predetermined period has lapsed with no voice inputted or when the talk switch 16 is operated again while the inputting process is being active.

While the present invention has been shown and described with reference to the foregoing preferred embodiment, it will be apparent to those skilled in the art that changes in form and detail may be made therein without departing from the scope of the invention as defined in the appended claims.

What is claimed is:

1. An input device comprising:
means for inputting voice information;
means for recognizing the inputted voice information;
means for displaying keys corresponding to the voice information; and
means for controlling the displaying means in such a manner that the keys are displayed in sizes enlarged according to a degree of coincidence with data in a voice recognition dictionary.

2. The input device as in claim 1, wherein the voice information is a syllable or a word.

3. The input device as in claim 1, wherein the voice information constitutes a command to the input device.

4. The input device as in claim 1, wherein the recognizing means calculates the degree of coincidence in recognition of each inputted voice information.

5. The input device as in claim 1, wherein the keys corresponding to the voice information is finalized by a user.

6. The input device as in claim 1, wherein the controller gradually enlarges the size of the keys displayed when they are to be enlarged.

7. The input device as in claim 1, wherein the controller returns the keys displayed in an enlarged size to an initial size after a predetermined period.

8. The input device as in claim 7, wherein the controller gradually reduces the size of the displayed keys.

9. The input device as in claim 1, wherein the controller reduces the size of the displayed keys having the degree of coincidence lower than a predetermined level.

10. The input device as in claim 9, wherein the controller gradually reduces the size of the displayed keys.

11. The input device as in claim 9, wherein the controller returns the keys displayed in a reduced size to an initial size after a predetermined period.

12. The input device as in claim 11, wherein the controller gradually enlarges the keys displayed in the reduced size to the initial size.

13. The input device as in claim 1, wherein the controller displays the keys in such a manner that the keys are not overlapped one another when they are displayed in an enlarged size.

14. The input device as in claim 1, wherein the controller controls the displaying means in such a manner that the keys displayed do not become invisible when some keys are enlarged.

15. The input device as in claim 1, wherein the controller controls the displaying means in such a manner that the enlarged keys are displayed to overlap on other keys which are not enlarged.

16. The input device as in claim 1, wherein the controller controls the displaying means in such a manner that, when some keys are displayed in an enlarged size, other keys are not displayed.

17. The input device as in claim 1, wherein the voice inputting means is kept in operation while the input device is being in operation.

18. The input device as in claim 1, wherein the voice recognizing means starts its operation upon starting the voice inputting means.

19. The input device as in claim 1, wherein the input device is mounted on an automotive vehicle.
